(19) United States
(12) Patent Application Publication
(10) Pub. No.: US 2025/0012658 A1
(43) Pub. Date: Jan. 9, 2025

(54) METHOD OF CONSTRUCTING WATER SUPPLY PIPELINE LEAKAGE IDENTIFICATION MODEL BASED ON DEEP LEARNING AND APPLICATION THEREOF

(71) Applicants: Innovation Center of Yangtze River Delta, ZJU, Jiaxing City (CN); Zhejiang University, Hangzhou City (CN)

(72) Inventors: Yonggang SHEN, Jiaxing City (CN); Tuqiao ZHANG, Jiaxing City (CN); Tingchao YU, Jiaxing City (CN); Hongliang YU, Jiaxing City (CN)

(21) Appl. No.: 18/755,504

(22) Filed: Jun. 26, 2024

(30) Foreign Application Priority Data
Jun. 29, 2023 (CN) 202310784797.8

(51) Int. Cl. G01M 3/24; G10L 25/24; G10L 25/30

(52) U.S. Cl. CPC G01M 3/243

(57) ABSTRACT

A method of constructing a water supply pipeline leakage identification model based on deep learning and an application thereof are provided, which relate to the technical field of nondestructive detection and positioning of municipal water supply pipeline leakage. By extracting Mel-frequency cepstral coefficient of leakage sound signals as a basis for distinguishing pipeline leakage, a neural memory network is introduced to learn leakage features and establish a leakage feature neural network model, and the features of a signal of a point to be detected are input into the model to determine whether the point leaks, so as to realize accurate positioning of the pipeline leakage position.

### CROSS-REFERENCE TO RELATED APPLICATION

This patent application claims the benefit of and priority to Chinese Patent Application No. 202310784797.8, filed with the Chinese Patent Office on Jun. 29, 2023, which is hereby incorporated by reference herein in its entirety.

### TECHNICAL FIELD

The present disclosure relates to the technical field of nondestructive detection and positioning of leakage of urban water supply pipelines in municipal engineering, and in particular, to a method of constructing a water supply pipeline leakage identification model based on deep learning and an application thereof.

### BACKGROUND

Due to the aging of water supply pipelines, uneven construction quality and pipeline material quality, a leakage rate of water supply pipeline network in China has been kept above 12%, and the leakage amount is huge, resulting in a huge waste of water resources. In addition, pipeline leakage often leads to some secondary disasters, such as road collapse. Therefore, the leakage detection of the water supply network is an urgent problem to be solved.

At present, the most commonly used leakage detection method for water companies is auditory leakage detection method. The method has the advantages of low equipment cost and easy operation. However, there are some defects in this method. First, the requirements for leakage listening people are relatively high, and only those with professional training or rich experience can find the location of the leakage point. Second, it poses high requirements on working environment, and the quiet surrounding environment is required during listening. Third, the leakage detection speed is slow.

In practical engineering, because of the diversity and complexity of operating conditions of underground medium and water supply pipelines, the listening effect is often affected, and there are the following problems.
(1) The analysis process of the leakage sound signal mainly depends on the experience of engineers, and the accuracy is unstable.
(2) The collected leakage signal only pays attention to the frequency range and amplitude, so that it is difficult to analyze the location of the leakage point.
(3) It is difficult to express the leaked sound signal in a standard term.

Therefore, how to analyze the leakage signal and analyze its features has become the key problem of pipeline leakage detection by listening.

### SUMMARY

In order to solve the above problems, the present disclosure provides the following technical scheme.

The present disclosure provides a method of constructing a water supply pipeline leakage identification model based on deep learning, comprising:
(1) acquiring leakage sound signals;
(2) preprocessing the leakage sound signals to obtain processed leakage sound signals;
(3) calculating Mel-frequency cepstral coefficients of the processed leakage sound signals, as leakage identification features; and
(4) learning features of the leakage sound signals based on a deep learning algorithm to construct a leakage identification model.

Further, the method of acquiring leakage sound signals in step (1) comprises:
setting different working conditions (different pipe diameters, different pipe materials, different leakage forms, different leakage sizes, different buried pipe media, and different leakage orientations) to select an appropriate sound sensor, a sampling frequency, an appropriate detecting line and a distance between various detecting points on the detecting line, and collecting a large number of the leakage sound signals and non-leakage signals at the detecting points;
where the sound sensor has the sampling frequency of at least 4000 Hz;
according to a position of a nozzle of a water supply pipeline, a position of an axis of the water supply pipeline is determined, and the axis of the pipeline is set as the detecting line, and detecting points are arranged at a certain spacing distance on the detecting line, usually at a distance of 50 cm or 25 cm apart.

Further, the preprocessing in step (2) comprises pre-emphasizing, framing, and windowing;
the step (2) comprises:
(21) for each leakage sound signal collected, using a first-order FIR high-pass filter to enhance a high-frequency part of the leakage sound signal, because it is inevitable that the signal will generate leakage identification in the transmission process, the high frequency decays faster than the low frequency, the information in the high-frequency part will become relatively vague, and the signal-to-noise ratio of the high frequency can be greatly improved through pre-emphasizing; where a design algorithm of the first-order FIR high-pass filter is shown as follows:

$$y ( n ) = x ( n ) - u x ( n - 1 ) \qquad Formula ( 1 )$$

where x(n) is a signal time series, u is a pre-emphasizing coefficient which is usually 0.97, and y(n) is a pre-emphasizing signal;
(22) framing the leakage sound signal to ensure that the leakage sound signal is in a stable state, because the input signal needs to be in a stable state during signal processing, where the signal is divided, and if the time of the divided signal is short enough, it can be considered that the signal is relatively stable;
(23) windowing the leakage sound signal to reduce signal leakage caused by Fourier transform;
windowing is conducted because when Fourier transform is performed, aperiodic signals will produce signal leakage, while periodic signals will not, and through windowing, the signal can be as periodic as possible, and the signal leakage produced during Fourier transform can be reduced; a Hamming window is usually used, and a calculation method is as follows:

$$w [ n ] = \frac{1}{2} [ 1 + cos ( 2 π \frac{n}{N - 1} ) \qquad Formula ( 2 )$$

where n is a position of a sequence of detecting points, and N is a total number of the detecting points.

Further, the step of step (3) comprises:
(31) performing fast Fourier transform on the preprocessed leakage sound signal xi(n) of each frame, and converting the leakage sound signal xᵢ(n) from a time domain dimension to a frequency domain:

$$X ( i , o ) = FFT [ {x}_{i} ( n ) ] \qquad Formula ( 3 )$$

calculating a spectral energy of the leakage sound signal of each frame after fast Fourier transform as follows:

$$E ( i , o ) = {[ X ( i , o ) ]}^{2} \qquad Formula ( 4 )$$

where i represents an i-th frame of the leakage sound signal in time domain, and o represents an o-th spectral line of the leakage sound signal in frequency domain;
(32) defining a Mel filter bank with M (usually 22-26) filters, where each filter adopts a triangular filter with a center frequency of f(m), an interval between the center frequencies f(m) decreases with decrease of m value and widens with increase of m value; and a frequency response of the triangular filter is defined as:

$${H}_{m} ( k ) = \{ \begin{matrix}0 , k < f ( m - 1 ) \\ \frac{2 ( k - f ( m - 1 ) )}{( f ( m + 1 ) - f ( m - 1 ) ) ( f ( m ) - f ( m - 1 ) )} , f ( m - 1 ) \leq k \leq f ( m ) \\ \frac{2 ( k ( m + 1 ) - k )}{( f ( m + 1 ) - f ( m - 1 ) ) ( f ( m ) - f ( m - 1 ) )} , f ( m ) \leq k \leq f ( m + 1 ) \\ 0 , k \geq f ( m + 1 )\end{matrix} \qquad Formula ( 5 )$$

where k represents a frequency of the triangular filter, and m represents an m-th triangular filter;
a calculation method of the center frequency f(m) is as follows:

$$f ( m ) = ( \frac{L}{{f}_{s}} ) {F}_{m e l}^{- 1} ( {F}_{m e l} ( {f}_{l} ) + m \frac{{F}_{m e l} ( {f}_{h} ) - {F}_{m e l} ( {f}_{l} )}{M + 1} \qquad Formula ( 6 )$$

where fₕ and fₗ are the maximum and minimum cutoff frequencies of the triangular filter, L is a signal length calculated by a Fast Fourier Transform (FFT), fₛ is a sampling frequency of a signal, Fₘₑₗ is a perceptual frequency in Mel, and Mel scale describes nonlinear features of a human ear frequency, and has a relationship with frequency which is approximately expressed by a following formula:

$${F}_{m e l} ( f ) = 1125 ln ( 1 + \frac{f}{700} ) \qquad Formula ( 7 )$$

where f is a frequency in Hz, and an inverse function Fₘₑₗ⁻¹ of Fₘₑₗ is expressed as:

$${F}_{m e l}^{- 1} ( b ) = 700 ( {e}^{\frac{b}{1125}} - 1 ) \qquad Formula ( 8 )$$

where b is a frequency of the Mel scale;
the calculated spectral energy of each frame passes through the Mel filter bank to obtain a filtered energy shown as follows:

$$S ( i , m ) = E ( i , o ) {H}_{m} ( k ) \qquad Formula ( 9 )$$

(33) calculating a logarithm of the filtered energy and performing discrete cosine transform to obtain a standard Mel-frequency cepstral coefficients;

$$mfcc ( i , r ) = \sqrt{\frac{2}{M}} {\sum }_{m = 0}^{M - 1} log [ S ( i , m ) cos ( \frac{π r ( 2 m - 1 )}{2 M} ) ] \qquad Formula ( 10 )$$

where r is a r-th spectral line after discrete cosine transform;
(34) describing a dynamic feature of the Mel-frequency cepstral coefficient with a difference spectrum of the static feature, as the standard Mel-frequency cepstral coefficient only reflect a static feature of speech parameters, where a calculation formula of the difference spectrum is:

$${d}_{t} = \{ \begin{matrix}{C}_{t} - {C}_{t - 1} , t < K \\ \frac{{\sum }_{k = 1}^{K} k ( {C}_{t + k} - {C}_{t - k} )}{2 {\sum }_{k = 1}^{K} {k}^{2}} , else \\ {C}_{t} - {C}_{t - 1} , t \geq Q - K\end{matrix} \qquad Formula ( 11 )$$

where dₜ represents a t-th first-order difference;
Cₜ represents a t-th cepstral coefficient;
Q represents an order of a cepstral coefficient;
K represents a time difference of a first-order derivative;
a result in Formula 11 is substituted into Formula 11 again to obtain parameters of a second-order difference;
(35) where the Mel-frequency cepstral coefficient comprise the static feature of the standard Mel-frequency cepstral coefficients and the dynamic feature of the standard Mel-frequency cepstral coefficients, and a final Mel-frequency cepstral coefficients in D dimension consists of standard Mel-frequency cepstral coefficient in D/3 dimension, the first-order difference parameter in D/3 dimension and the second-order difference parameter in D/3 dimension. Combining the dynamic feature and the static feature can effectively improve the identification performance of the system.

Further, the step (4) includes:
adding a carry track on the basis of a standard neural network as a deep learning algorithm; obtaining a neural network model for leakage identification through learning the Mel-frequency cepstral coefficient of the leakage sound signal by a long-short-term neural network, where the Mel-frequency cepstral coefficient of the leakage sound signal to be identified is used as an input of the model and a leakage probability of the detecting point is an output of the model.

The present disclosure provides a leakage detection method based on deep learning by a water supply pipeline leakage identification model which is constructed according to the above methods.

The leakage detection method includes: selecting a detecting line in a leakage detection area of a water supply pipeline; collecting a sound signal; performing pre-emphasizing, framing, windowing, fast Fourier transform, Mel filter bank filtering and discrete Fourier transform on the sound signal to obtain a static feature of a standard Mel-frequency cepstral coefficient; performing first-order difference and second-order difference on the static feature to obtain a dynamic feature of the standard Mel-frequency cepstral coefficient; and, inputting the static feature and the dynamic feature of the standard Mel-frequency cepstral coefficient into the leakage identification model, and determining whether a leakage occurs at this point by an outputted leakage probability.

### Beneficial Effects

(1) The present disclosure extracts Mel-frequency cepstral coefficients of a leakage sound signal as a basis for distinguishing pipeline leakage, a neural memory network is introduced to learn leakage features and establish a leakage feature neural network model, and the features of a signal of a point to be detected are input into the model to determine whether the point leaks, so as to realize accurate positioning of the pipeline leakage position
(2) In the aspect of pipeline leakage detection, the present disclosure changes the traditional sound listening leakage detection method, extracts the features of the leakage signal by collecting and processing sound data, compares the features with the leakage identification model, judges the amplitude attribute of the leakage at the point to be detected, and carries out high-resolution imaging on the leakage features, so as to determine the scale of pipeline leakage and detect whether the pipeline leakage occurs more efficiently and accurately.
(3) The Mel-frequency cepstral coefficients with a higher identification degree of sound features are extracted, and a long-short-term neural network model is introduced to construct a leakage signal feature library; during detection, the leakage position can be detected in real time according to the leakage identification model without relying on the leakage detection experience of workers. The machine can intelligently identify whether leakage occurs, which can greatly speed up the detection efficiency and reduce the burden of leakage detection workers.

### BRIEF DESCRIPTION OF THE DRAWINGS

FIG. 1 is a flow chart of model construction according to the present disclosure; and

FIG. 2 is a schematic diagram of a neural memory network.

### DETAILED DESCRIPTION OF THE EMBODIMENTS

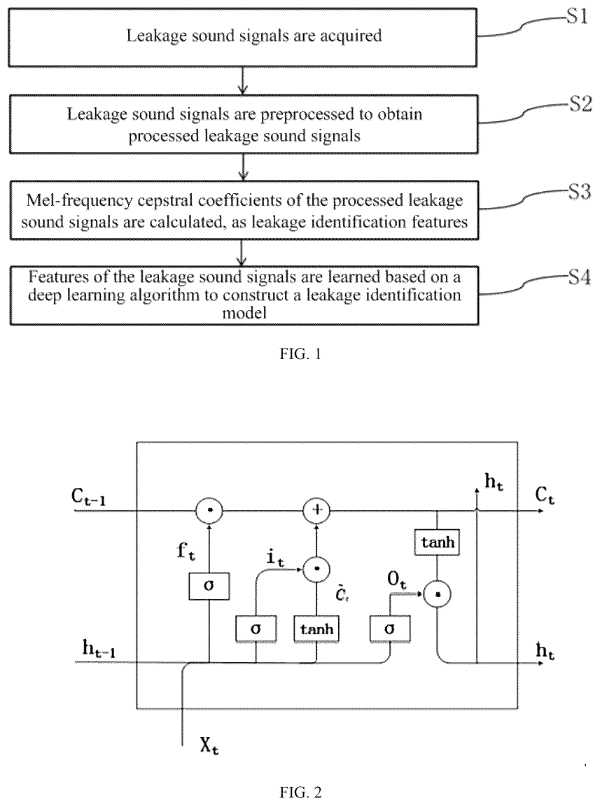

As shown in FIG. 1, the present disclosure provides a method of constructing a water supply pipeline leakage identification model based on deep learning, comprising the following steps.

In step S1, a leakage sound signal is acquired. Specifically, for each of different working conditions being set, an appropriate sound sensor, a sampling frequency, an appropriate detecting line and a distance between various detecting point on the detecting line are adopted, and a large number of leakage sound signals and non-leakage signals at the detecting points are collected.

Where different working conditions comprise different pipe diameters, pipe materials, leak forms, leak sizes, pipe burying media, and leak orientations.

The sound sensor has a sampling frequency of at least 4000 Hz;

According to a position of a nozzle of a water supply pipeline, a position of an axis of the water supply pipeline is determined, the axis of the pipeline is set as the detecting line, and detecting points are arranged at a certain spacing distance on the detecting line, usually at a distance of 50 cm or 25 cm apart.

In step S2, the leakage sound signal is preprocessed to obtain a processed leakage sound signal.

Preprocessing comprises pre-emphasizing, framing, and windowing. The specific steps are described as follows.

In step (21), for the collected leakage sound signal, a first-order FIR high-pass filter is used to enhance a high-frequency part of the leakage sound signal, because the signal loss may occur in the transmission process, and the high frequency decays faster than the low frequency, resulting in that the information in the high-frequency part becomes relatively vague. The signal-to-noise ratio of the high frequency can be greatly improved through pre-emphasizing, and a design algorithm of the first-order FIR high-pass filter is shown as follows:

$$y ( n ) = x ( n ) - u x ( n - 1 ) , \qquad Formula ( 1 )$$

where x(n) is a signal time series, u is a pre-emphasizing coefficient which is usually 0.97, and y(n) is a pre-emphasizing signal.

In step (22), the leakage sound signal is framed to ensure that the leakage sound signal is in a stable state, where the signal is divided, and if the time of the divided signal is short enough, it can be considered that the signal is relatively stable.

In step (23), the leakage sound signal is windowed to reduce signal leakage caused by Fourier transform.

Windowing is conducted because when Fourier transform is performed, aperiodic signals will produce signal leakage, while periodic signals will not, and through windowing, the signal can be as periodic as possible, and the signal leakage produced during Fourier transform can be reduced. a Hamming window is usually used, and a calculation method is as follows:

$$w [ n ] = \frac{1}{2} [ 1 + cos ( 2 π \frac{n}{N - 1} ) ] \qquad Formula ( 2 )$$

where n is a position of a detecting point sequence, and N is a total number of detecting points.

In step S3, a Mel-frequency cepstral coefficient of the processed leakage sound signal is calculated, and the coefficient is taken as a leakage identification feature.

The specific steps are described as follows.

In step (31), fast Fourier transform (FFT) is performed on the preprocessed leakage sound signal xᵢ(n) of each frame, and the leakage sound signal xᵢ(n) is converted from a time domain dimension to a frequency domain dimension:

$$X ( i , o ) = FFT [ {x}_{i} ( n ) ] \qquad Formula ( 3 )$$

a spectral energy of the leakage sound signal of each frame after fast Fourier transform is calculated as follows:

$$E ( i , o ) = {[ X ( i , o ) ]}^{2} \qquad Formula ( 4 )$$

where i represents an i-th frame of the leakage sound signal in time domain, and o represents an o-th spectral line of the leakage sound signal in frequency domain.

In step (32), a Mel filter bank with M (usually 22-26) filters is defined, where the filters adopt triangular filters with a center frequency of f(m), the interval between the center frequencies f(m) decreases with the decrease of m value and widens with the increase of m value; and a frequency response of the triangular filter is defined as:

$${H}_{m} ( k ) = \{ \begin{matrix}0 , k < f ( m - 1 ) \\ \frac{2 ( k - f ( m - 1 ) )}{( f ( m + 1 ) - f ( m - 1 ) ) ( f ( m ) - f ( m - 1 ) )} , f ( m - 1 ) \leq k \leq f ( m ) \\ \frac{2 ( k ( m + 1 ) - k )}{( f ( m + 1 ) - f ( m - 1 ) ) ( f ( m ) - f ( m - 1 ) )} , f ( m ) \leq k \leq f ( m + 1 ) \\ 0 , k \geq f ( m + 1 )\end{matrix} \qquad Formula ( 4 )$$

where k represents a frequency of the triangular filter, and m represents an m-th triangular filter.

A calculation method of the center frequency f(m) is as follows:

$$f ( m ) = ( \frac{L}{{f}_{s}} ) {F}_{m e l}^{- 1} ( {F}_{m e l} ( {f}_{l} ) + m \frac{{F}_{m e l} ( {f}_{h} ) - {F}_{m e l} ( {f}_{l} )}{M + 1} \qquad Formula ( 6 )$$

where fₕ and fₗ are the maximum and minimum cutoff frequencies of the triangular filter, L is a signal length calculated by a Fast Fourier Transform (FFT), fₛ is a sampling frequency of a signal, Fₘₑₗ is a perceptual frequency in unit of Mel. The Mel scale describes nonlinear features of a human ear frequency, and has a relationship with frequency which is approximately expressed by a following formula:

$${F}_{m e l} ( f ) = 1125 ln ( 1 + \frac{f}{700} ) \qquad Formula ( 7 )$$

where f is a frequency in H_{z} and an inverse function Fₘₑₗ⁻¹ of Fₘₑₗ is expressed as:

$${F}_{m e l}^{- 1} ( b ) = 700 ( {e}^{\frac{b}{1125}} - 1 ) \qquad Formula ( 8 )$$

where b is a frequency of the Mel scale.

The calculated spectral energy of each frame passes through the Mel filter bank to obtain a filtered energy shown as follows:

$$S ( i , m ) = E ( i , o ) {H}_{m} ( k ) \qquad Formula ( 9 )$$

In step (33), a logarithm of the filtered energy is calculated and subjected to Discrete Cosine Transform (DCT) to obtain standard Mel-frequency cepstral coefficient;

$$mfcc ( i , r ) = \sqrt{\frac{2}{M}} {\sum }_{m = 0}^{M - 1} log [ S ( i , m ) cos ( \frac{π r ( 2 m - 1 )}{2 M} ) ] \qquad Formula ( 10 )$$

where r is a r-th spectral line after discrete cosine transform.

In step (34), the standard Mel-frequency cepstral coefficient only reflect a static feature of a speech parameter, a dynamic feature of the Mel-frequency cepstral coefficient is described by a difference spectrum of the static feature, and a calculation formula of the difference spectrum is:

$${d}_{t} = \{ \begin{matrix}{C}_{t} - {C}_{t - 1} , & t < K \\ \frac{{\sum }_{k = 1}^{K} k ( {C}_{t + k} - {C}_{t - k} )}{2 {\sum }_{k = 1}^{K} {k}^{2}} , & else \\ {C}_{t} - {C}_{t - 1} , & t \geq Q - K\end{matrix} \qquad Formula ( 11 )$$

where dₜ represents a t-th first-order difference;
Cₜ represents a t-th cepstral coefficient;
Q represents an order of a cepstral coefficient;
K represents a time difference of a first-order derivative.

A result from Formula 11 is substituted into Formula 11 again to obtain parameters of a second-order difference;

In step (35), the Mel-frequency cepstral coefficient comprises the static feature of the standard Mel-frequency cepstral coefficient and the dynamic feature of the standard Mel-frequency cepstral coefficient, and a final Mel-frequency cepstral coefficient in D dimension consists of the standard Mel-frequency cepstral coefficient in D/3 dimension, the first-order difference parameters in D/3 dimension and the second-order difference parameters in D/3 dimension. Combining the dynamic feature and the static feature can effectively improve the identification performance of the system.

In step S4, based on a deep learning algorithm, learning of a leakage signal feature is completed, and a leakage identification model is constructed.

The specific process is described as follows.

A deep learning algorithm is a neural network, and a carry track is added on the basis of a standard neural network. The long-distance learning ability of the RNN is optimized, which is more suitable for dealing with long-term dependence and avoiding gradient disappearance and gradient explosion. The LSTM neural network consists of an input layer, an output layer, and several recursive hidden layers. The recursive hidden layers consist of memory units, and each of the memory units comprises one or more self-connected memory cells for linear feedback transmission, thus strengthening the connection among neurons.

As shown in FIG. 3, the LSTM neural network introduces the mechanism of gates to control the accumulation speed of information and provide writing, reading, and resetting operations for memory units. Each of the memory units comprises three gates: an input gate, a forgetting gate, and an output gate. The input gate (iₜ) determines the information that needs to be updated, the forgetting gate (fₜ) determines the information that neurons need to discard, and the output gate (Oₜ) determines the information that needs to be output. These gates multiply with a sigmoid neural layer point by point to complete screening of the information and then influence the state of the next memory unit by the carry track. Assume that at time t, the input sequence X=(X₁, X₂, X₃, . . . , X_{T}) is known, and in the recursive hidden layer, the activation values of three gates and memory units are sequentially calculated according to time t=1˜T. At this time, the value range of three gate elements is [0, 1], and the algorithm of the LSTM at time t is as follows.

Assuming that W is a weight vector of the gate and b is a bias term. The gate can be expressed as: g(x)=σ(Wx+b), where σ is a sigmoid function. Because its range is (0, 1), the state of the gate is half open and half closed.

The input gate:

$${i}_{t} = σ ( {W}_{i} \cdot [ {h}_{t - 1} , {X}_{t} ] + {b}_{i} ) ,$$

the forgetting gate:

$${f}_{t} = σ ( {W}_{f} \cdot [ {h}_{t - 1} , {X}_{t} ] + {b}_{f} ) .$$

where W_{f} is a weight matrix of the forgetting gate, [hₜ₋₁, Xₜ] represents connecting two vectors into a longer vector, and b_{f} is a bias term of the forgetting gate.

The memory cell:

$$\begin{matrix}{\tilde{C}}_{t} = tanh ( {W}_{c} \cdot [ {h}_{t - 1} , {X}_{t} ] + {b}_{c} ) \\ {C}_{t} = {f}_{t} \cdot {C}_{t - 1} + {i}_{c} \cdot {\tilde{C}}_{t}\end{matrix}$$

Cₜ₋₁ is the unit state at the last time; Cₜ is the unit state at the current time. The output gate:

$${O}_{t} = σ ( {W}_{o} \cdot [ {h}_{t - 1} , {X}_{t} ] + {b}_{o} ) ,$$

the hidden layer output:

hₜ=Oₜ·tanh(Cₜ),
where hₜ₋₁ is the output of the last neuron, and hₜ is the output of the neuron at time t.

A neural network model for leakage identification is obtained through learning the Mel-frequency cepstral coefficient of the leakage signal by a long-short-term neural network, and the Mel-frequency cepstral coefficient of the leakage signal to be identified is used as an input of the model and a leakage probability of the detecting point is an output of the model.

The present disclosure provides an application of a water supply pipeline leakage identification model based on deep learning, which is applied to a water supply pipeline leakage feature identification system.

The specific steps are as follows: selecting a detecting line in a leakage detection area of a water supply pipeline; collecting a sound signal; performing pre-emphasizing, framing, windowing, fast Fourier transform, Mel filter bank filtering and discrete Fourier transform to obtain a static feature of standard Mel-frequency cepstral coefficient, and then performing first-order difference and second-order difference on the static feature to obtain a dynamic eigenvalue of the standard Mel-frequency cepstral coefficients; thereafter, inputting the static feature and the dynamic feature of the standard Mel-frequency cepstral coefficient into a leakage identification model, and determining whether leakage occurs at this point by outputted the leakage probability.

### EMBODIMENT

In this embodiment, leakage detection is performed on a leaking water supply pipeline.

In a first step, a leakage sound signal is acquired, which is collected in the scene of original soil, a DN100 ductile iron pipe and a leak of 6 mm in the shape of a hole. The acquisition device is a sound sensor. According to a position of a nozzle of a water supply pipeline, a position of an axis of the water supply pipeline is determined. The axis of the pipeline is set as the detecting line. Detecting lines are arranged along the pipeline. A detecting point is selected every 25 cm, and the sampling frequency is 44100 Hz.

In a second step, the collected leakage sound signal is emphasized, framed, and windowed to obtain a processed leakage sound signal.

In a third step, Fourier transform is performed on the processed leakage sound signal. A Mel filter bank is constructed, and the signal is filtered. Specifically, the spectrum energy passes through triangular Mel filter bank at a Mel scale. The number of triangular filters is set as 22. Logarithm of the filtered sound signal is calculated, and then subjected to discrete cosine transform to obtain the static feature of the standard Mel-frequency cepstral coefficient. The first-order difference and the second-order difference are performed on the static feature of the standard Mel-frequency cepstral coefficient to obtain the dynamic feature of the standard Mel-frequency cepstral coefficient.

In a fourth step, the static feature and the dynamic feature of the standard Mel-frequency cepstral coefficient are used as the input of the leakage identification model to obtain the probability that the point is identified as “leakage.” When the leakage identification probability is 100%, the detection point is determined to be a leakage point, and the probability on both sides of the leakage point is gradually decreasing. When a leakage point is found, the leakage detection is finished.

What is claimed is:

1. A method of constructing a water supply pipeline leakage identification model based on deep learning, comprising:
(1) acquiring leakage sound signals;
(2) preprocessing the leakage sound signals to obtain processed leakage sound signals;
(3) calculating Mel-frequency cepstral coefficients of the processed leakage sound signals, as leakage identification features; and
(4) learning features of the leakage sound signals based on a deep learning algorithm to construct a leakage identification model.

2. The method according to claim 1, wherein the acquiring leakage sound signals in step (1) comprises:
setting different working conditions to select an appropriate sound sensor, a sampling frequency, an appropriate detecting line and a distance between various detecting points on the detecting line, and collecting a large number of the leakage sound signals at the detecting points;
wherein the sound sensor has the sampling frequency of at least 4000 Hz; according to a position of a nozzle of a water supply pipeline, a position of an axis of the water supply pipeline is determined, and the axis of the pipeline is set as the detecting line.

3. The method according to claim 1, wherein the preprocessing in step (2) comprises pre-emphasizing, framing, and windowing;
wherein the step (2) comprises:
(21) for each leakage sound signal collected, using a first-order FIR high-pass filter to enhance a high-frequency part of the leakage sound signal, wherein a design algorithm of the first-order FIR high-pass filter is shown as follows:
$$y ( n ) = x ( n ) - u x ( n - 1 ) \qquad Formula ( 1 )$$
wherein x(n) is a signal time series, u is a pre-emphasizing coefficient which is usually 0.97, and y(n) is a pre-emphasizing signal;
(22) framing the leakage sound signal to ensure that the leakage sound signal is in a stable state;
(23) windowing the leakage sound signal to reduce signal leakage caused by Fourier transform, wherein a Hamming window is usually used, and a calculation method is as follows:
$$w [ n ] = \frac{1}{2} [ 1 + cos ( 2 π \frac{n}{N - 1} ) \qquad Formula 2$$
wherein n is a position of a sequence of detecting points, and N is a total number of the detecting points.

4. The method according to claim 1, wherein the step (3) comprises:
(31) performing fast Fourier transform on the preprocessed leakage sound signal xᵢ(n) of each frame, and converting the leakage sound signal xᵢ(n) from a time domain dimension to a frequency domain, wherein a formula of the fast Fourier transform is as follows:
$$X ( i , o ) = FFT [ {x}_{i} ( n ) ] \qquad Formula ( 3 )$$
calculating a spectral energy of the leakage sound signal of each frame after fast Fourier transform as follows:
$$E ( i , o ) = {[ X ( i , o ) ]}^{2} \qquad Formula ( 4 )$$
wherein i represents an i-th frame of the leakage sound signal in time domain, and o represents an o-th spectral line of the leakage sound signal in frequency domain;
(32) defining a Mel filter bank with M filters, wherein each filter adopts a triangular filter with a center frequency of f(m), an interval between the center frequencies f(m) decreases with decrease of m value and widens with increase of m value; and a frequency response of the triangular filter is defined as:
$$Formula 5$$
$${H}_{m} ( k ) = \{ \begin{matrix}0 , & k < f ( m - 1 ) \\ \frac{2 ( k - f ( m - 1 ) )}{( f ( m + 1 ) - f ( m - 1 ) ) ( f ( m ) - f ( m - 1 ) )} , & f ( m - 1 ) \leq k \leq f ( m ) \\ \frac{2 ( f ( m + 1 ) - k )}{( f ( m + 1 ) - f ( m - 1 ) ) ( f ( m ) - f ( m - 1 ) )} , & f ( m ) \leq k \leq f ( m + 1 ) \\ 0 , & k \geq f ( m + 1 )\end{matrix}$$
wherein k represents a frequency of the triangular filter, and m represents an m-th triangular filter;
a calculation method of the center frequency f(m) is as follows:
$$f ( m ) = ( \frac{L}{{f}_{s}} ) {F}_{m e l}^{- 1} ( {F}_{m e l} ( {f}_{l} ) + m \frac{{F}_{m e l} ( {f}_{h} ) - {F}_{m e l} ( {f}_{l} )}{M + 1} \qquad Formula ( 6 )$$
wherein fₕ and fₗ are the maximum and minimum cutoff frequencies of the triangular filter, L is a signal length calculated by a Fast Fourier Transform (FFT), fₛ is a sampling frequency of a signal, Fₘₑₗ is a perceptual frequency in Mel, and Mel scale describes nonlinear features of a human ear frequency, and has a relationship with frequency which is approximately expressed by a following formula:
$${F}_{m e l} ( f ) = 1125 ln ( 1 + \frac{f}{700} ) \qquad Formula ( 7 )$$
wherein f is a frequency in Hz, and an inverse function Fₘₑₗ⁻¹ of Fₘₑₗ is expressed as:
$${F}_{mel}^{- 1} ( b ) = 700 ( {e}^{\frac{b}{1125}} - 1 ) \qquad Formula ( 8 )$$
wherein b is a frequency o the Me scale;
the calculated spectral energy of each frame passes through the Mel filter bank to obtain a filtered energy shown as follows:
$$S ( i , m ) = E ( i , o ) {H}_{m} ( k ) \qquad Formula ( 9 )$$
(33) calculating a logarithm of the filtered energy and performing discrete cosine transform to obtain a standard Mel-frequency cepstral coefficient;
$$mfcc ( i , r ) = \sqrt{\frac{2}{M}} {\sum }_{m = 0}^{M - 1} log [ S ( i , m ) cos ( \frac{π r ( 2 m - 1 )}{2 M} ) ] \qquad Formula ( 10 )$$
wherein r is a r-th spectral line after discrete cosine transform;
(34) describing a dynamic feature of the Mel-frequency cepstral coefficient with a difference spectrum of the static feature, as the standard Mel-frequency cepstral coefficient only reflect a static feature of speech parameters, wherein a calculation formula of the difference spectrum is:
$${d}_{t} = \{ \begin{matrix}{C}_{t} - {C}_{t - 1} , & t < K \\ \frac{{\sum }_{k = 1}^{K} k ( {C}_{t + k} - {C}_{t - k} )}{2 {\sum }_{k = 1}^{K} {k}^{2}} , & else \\ {C}_{t} - {C}_{t - 1} , & t \geq Q - K\end{matrix} \qquad Formula ( 11 )$$
wherein dₜ represents a t-th first-order difference;
Cₜ represents a t-th cepstral coefficient;
Q represents an order of a cepstral coefficient;
K represents a time difference of a first-order derivative;
a result in Formula 11 is substituted into Formula 11 again to obtain parameters of a second-order difference;
(35) wherein the Mel-frequency cepstral coefficient comprise the static feature of the standard Mel-frequency cepstral coefficient and the dynamic feature of the standard Mel-frequency cepstral coefficient, and a final Mel-frequency cepstral coefficient in D dimension consists of the standard Mel-frequency cepstral coefficient in D/3 dimension, the first-order difference parameter in D/3 dimension and the second-order difference parameter in D/3 dimension.

5. The method according to claim 1, wherein the step (4) comprises:
adding a carry track on the basis of a standard neural network as a deep learning algorithm; obtaining a neural network model for leakage identification through learning the Mel-frequency cepstral coefficient of the leakage sound signal by the neural network, wherein the Mel-frequency cepstral coefficient of the leakage sound signal to be identified is used as an input of the model and a leakage probability of the detecting point is an output of the model.

6. A leakage detection method based on deep learning by a water supply pipeline leakage identification model which is constructed according to claim 1, the leakage detection method comprising:
selecting a detecting line in a leakage detection area of a water supply pipeline;
collecting a sound signal;
performing pre-emphasizing, framing, windowing, fast Fourier transform, Mel filter bank filtering and discrete Fourier transform on the sound signal to obtain a static feature of a standard Mel-frequency cepstral coefficient;
performing first-order difference and second-order difference on the static feature to obtain a dynamic feature of the standard Mel-frequency cepstral coefficient; and
inputting the static feature and the dynamic feature of the standard Mel-frequency cepstral coefficient into the leakage identification model, and determining whether a leakage occurs at this point by an outputted leakage probability.

7. The leakage detection method according to claim 6, wherein the acquiring leakage sound signals in step (1) comprises:
setting different working conditions to select an appropriate sound sensor, a sampling frequency, an appropriate detecting line and a distance between various detecting points on the detecting line, and collecting a large number of the leakage sound signals at the detecting points;
wherein the sound sensor has the sampling frequency of at least 4000 Hz; according to a position of a nozzle of a water supply pipeline, a position of an axis of the water supply pipeline is determined, and the axis of the pipeline is set as the detecting line.

8. The leakage detection method according to claim 6, wherein the preprocessing in step (2) comprises pre-emphasizing, framing, and windowing;
wherein the step (2) comprises:
(21) for each leakage sound signal collected, using a first-order FIR high-pass filter to enhance a high-frequency part of the leakage sound signal, wherein a design algorithm of the first-order FIR high-pass filter is shown as follows:
$$y ( n ) = x ( n ) - ux ( n - 1 ) \qquad Formula ( 1 )$$
wherein x(n) is a signal time series, u is a pre-emphasizing coefficient which is usually 0.97, and y(n) is a pre-emphasizing signal;
(22) framing the leakage sound signal to ensure that the leakage sound signal is in a stable state;
(23) windowing the leakage sound signal to reduce signal leakage caused by Fourier transform, wherein a Hamming window is usually used, and a calculation method is as follows:
$$w [ n ] = \frac{1}{2} [ 1 + cos ( 2 π \frac{n}{N - 1} ) \qquad Formula 2$$
wherein n is a position of a sequence of detecting points, and N is a total number of the detecting points.

9. The leakage detection method according to claim 6, wherein the step (3) comprises:
(31) performing fast Fourier transform on the preprocessed leakage sound signal xᵢ(n) of each frame, and converting the leakage sound signal xᵢ(n) from a time domain dimension to a frequency domain, wherein a formula of the fast Fourier transform is as follows:
$$X ( i , o ) = FFT [ {x}_{i} ( n ) ] \qquad Formula ( 3 )$$
calculating a spectral energy of the leakage sound signal of each frame after fast Fourier transform as follows:
$$E ( i , o ) = {[ X ( i , o ) ]}^{2} \qquad Formula ( 4 )$$
wherein i represents an i-th frame of the leakage sound signal in time domain, and o represents an o-th spectral line of the leakage sound signal in frequency domain;
(32) defining a Mel filter bank with M filters, wherein each filter adopts a triangular filter with a center frequency of f(m), an interval between the center frequencies f(m) decreases with decrease of m value and widens with increase of m value; and a frequency response of the triangular filter is defined as:
$${H}_{m} ( k ) = \{ \begin{matrix}0 , & k < f ( m - 1 ) \\ \frac{2 ( k - f ( m - 1 ) )}{( f ( m + 1 ) - f ( m - 1 ) ) ( f ( m ) - f ( m - 1 ) )} , & f ( m - 1 ) \leq k \leq f ( m ) \\ \frac{2 ( f ( m + 1 ) - k )}{( f ( m + 1 ) - f ( m - 1 ) ) ( f ( m ) - f ( m - 1 ) )} , & f ( m ) \leq k \leq f ( m + 1 ) \\ 0 , & k \geq f ( m + 1 )\end{matrix} \qquad Formula 5$$
wherein k represents a frequency of the triangular filter, and m represents an m-th triangular filter;
a calculation method of the center frequency f(m) is as follows:
$$f ( m ) = ( \frac{L}{{f}_{s}} ) {F}_{mel}^{- 1} ( {F}_{mel} ( {f}_{l} ) + m \frac{{F}_{mel} ( {f}_{h} ) - {F}_{mel} ( {f}_{l} )}{M + 1} \qquad Formula ( 6 )$$
wherein fₕ and fₗ are the maximum and minimum cutoff frequencies of the triangular filter, L is a signal length calculated by a Fast Fourier Transform (FFT), fₛ is a sampling frequency of a signal, Fₘₑₗ is a perceptual frequency in Mel, and Mel scale describes nonlinear features of a human ear frequency, and has a relationship with frequency which is approximately expressed by a following formula:
$${F}_{mel} ( f ) = 1125 ln ( 1 + \frac{f}{700} ) \qquad Formula ( 7 )$$
wherein f is a frequency in Hz, and an inverse function Fₘₑₗ⁻¹ of Fₘₑₗ is expressed as:
$${F}_{mel}^{- 1} ( b ) = 700 ( {e}^{\frac{b}{1125}} - 1 ) \qquad Formula ( 8 )$$
wherein b is a frequency of the Mel scale;
the calculated spectral energy of each frame passes through the Mel filter bank to obtain a filtered energy shown as follows:
$$S ( i , m ) = E ( i , o ) {H}_{m} ( k ) \qquad Formula ( 9 )$$
(33) calculating a logarithm of the filtered energy and performing discrete cosine transform to obtain a standard Mel-frequency cepstral coefficient;
$$mfcc ( i , r ) = \sqrt{\frac{2}{M}} {\sum }_{m = 0}^{M - 1} log [ S ( i , m ) cos ( \frac{π r ( 2 m - 1 )}{2 M} ) ] \qquad Formula ( 10 )$$
wherein r is a r-th spectral line after discrete cosine transform;
(34) describing a dynamic feature of the Mel-frequency cepstral coefficient with a difference spectrum of the static feature, as the standard Mel-frequency cepstral coefficient only reflect a static feature of speech parameters, wherein a calculation formula of the difference spectrum is:
$${d}_{t} = \{ \begin{matrix}{C}_{t} - {C}_{t - 1} , & t < K \\ \frac{{\sum }_{k = 1}^{K} k ( {C}_{t + k} - {C}_{t - k} )}{2 {\sum }_{k = 1}^{K} {k}^{2}} , & else \\ {C}_{t} - {C}_{t - 1} , & t \geq Q - K\end{matrix} \qquad Formula ( 11 )$$
wherein dₜ represents a t-th first-order difference;
Cₜ represents a t-th cepstral coefficient;
Q represents an order of a cepstral coefficient;
K represents a time difference of a first-order derivative;
a result in Formula 11 is substituted into Formula 11 again to obtain parameters of a second-order difference;
(35) wherein the Mel-frequency cepstral coefficient comprise the static feature of the standard Mel-frequency cepstral coefficient and the dynamic feature of the standard Mel-frequency cepstral coefficient, and a final Mel-frequency cepstral coefficient in D dimension consists of the standard Mel-frequency cepstral coefficient in D/3 dimension, the first-order difference parameter in D/3 dimension and the second-order difference parameter in D/3 dimension.

10. The leakage detection method according to claim 6, wherein the step (4) comprises:
adding a carry track on the basis of a standard neural network as a deep learning algorithm; obtaining a neural network model for leakage identification through learning the Mel-frequency cepstral coefficient of the leakage sound signal by the neural network, wherein the Mel-frequency cepstral coefficient of the leakage sound signal to be identified is used as an input of the model and a leakage probability of the detecting point is an output of the model.
